(19) United States
(12) Patent Application Publication
(10) Pub. No.: US 2019/0158737 A1
(43) Pub. Date: May 23, 2019

(54) PANORAMIC CAMERA WITH INDEPENDENTLY CONTROLLED LENSES AND METHOD FOR CONTROLLING THE SAME

(71) Applicant: HON HAI PRECISION INDUSTRY CO., LTD., New Taipei (TW)

(72) Inventors: YI HSU, New Taipei (TW); CHI-HSUN HO, New Taipei (TW); CHUN-YEN KUO, New Taipei (TW)

(21) Appl. No.: 15/853,863

(22) Filed: Dec. 25, 2017

(30) Foreign Application Priority Data
Nov. 20, 2017 (TW) 106140184

(51) Int. Cl. H04N 5/232; G02B 13/06

(52) U.S. Cl. CPC H04N 5/23238; H04N 13/0242; G02B 13/06; H04N 5/23203

(57) ABSTRACT

A panoramic camera includes a casing and at least two lenses mounted to the casing. Each lens can be independently controlled. The panoramic camera further includes a wireless communication interface and a controller. The wireless communication interface receives a remote command from a mobile terminal, the command including information of at least one lens to be controlled and a type of operation required. The controller analyzes the remote command to determine which of the at least one lens is to be controlled and the type of the operation, and controls each determined lens to perform the determined operation.

### FIELD

The subject matter relates to cameras, and more particularly, to a panoramic camera and a method for controlling the panoramic camera.

### BACKGROUND

Panoramic cameras provide 360 degree views, making them suitable for overview applications in retail, garage forecourt, public space, residential, and reception areas. However, each lens of the panoramic camera must be manually controlled, which costs time. Furthermore, it may be inconvenient at times for manually operating the panoramic camera. Improvements in the art are preferred.

### BRIEF DESCRIPTION OF THE DRAWINGS

Implementations of the present technology will now be described, by way of example only, with reference to the attached figures.

FIG. 1 is a diagram of an exemplary embodiment of a panoramic camera of the present disclosure.

FIG. 2 is a block diagram of the panoramic camera of FIG. 1.

FIG. 3 is a flowchart of an exemplary embodiment of a method for controlling a panoramic camera.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

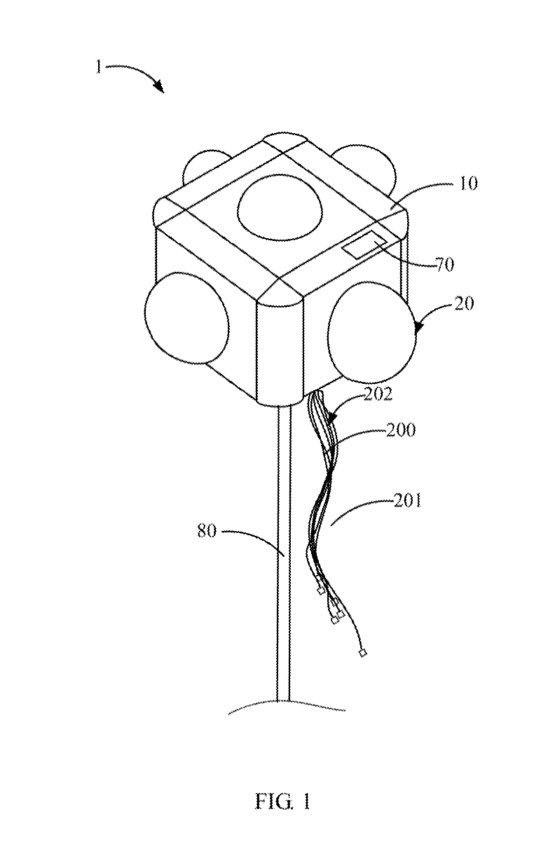

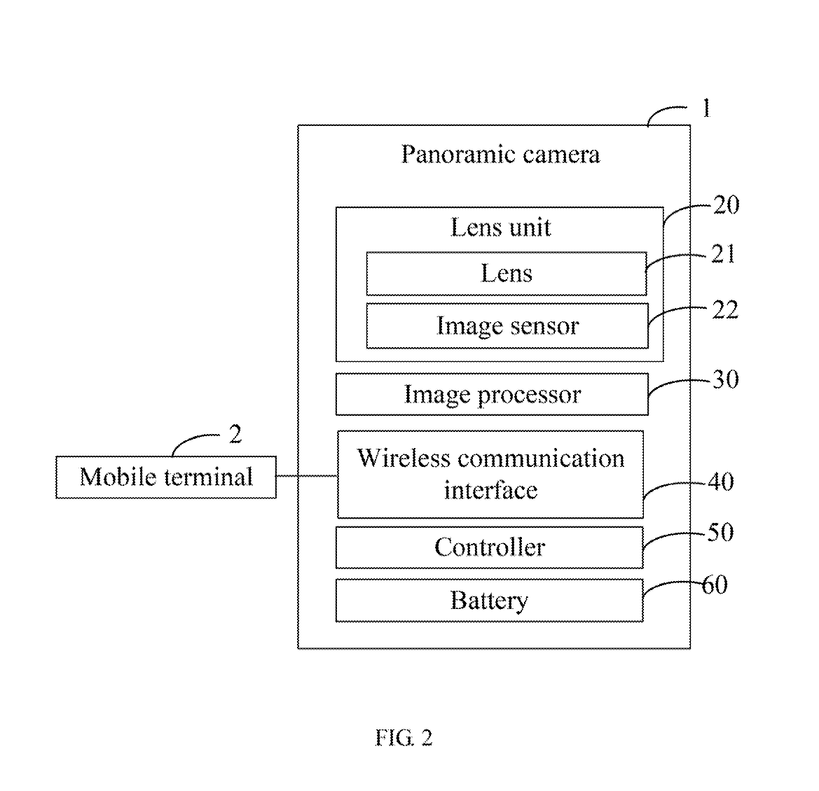

FIGS. 1 and 2 illustrate an exemplary embodiment of a panoramic camera 1. The panoramic camera 1 comprises a casing 10 and at least two lens units 20 mounted to the casing 10.

Each lens unit 20 comprises a lens 21 and an image sensor 22 positioned behind the lens 21. Each lens 21 can be independently controlled. Each lens 21 has a different field of view (FOV), thereby causing the panoramic camera 1 to cover a field of view of 360 degrees or 720 degrees. Each lens 21 collects light from objects in its field of view. Each image sensor 22 receives the collected light from the corresponding lens 21 to form images.

In at least one exemplary embodiment, the casing 10 is substantially cubic. In this exemplary embodiment, the lens units 20 number six, and are positioned at the top, the bottom, the left, the right, the front, and the back of the casing 10. Each lens 21 has a field of view of about 90 degrees. In another exemplary embodiment, the casing 10 can also have a different shape. For example, the casing 10 can be rectangular or spherical. The lens units 20 can also number two, three, four, and so on.

One or more image processors 30 (FIG. 2 only shows one image processor 30) are positioned in the casing 10. The image processor 30 is electrically connected to each image sensor 22. The image processor 30 obtains the images from each image sensor 22, and seams the obtained images to form a panoramic image.

The panoramic camera 1 can be switched between a remote mode and a manual mode. When the panoramic camera 1 is in the remote mode, each lens 21 can be controlled by a remote command to perform an operation. The types of the operation can be, but are not limited to, zoom in, zoom out, focal length adjustment, aperture adjustment, and any combination thereof.

A user can send the remote command to the panoramic camera 1 through a mobile terminal 2, thereby controlling each lens 21 to perform the operation. The mobile terminal 2 can be a remote control, a smart phone, or a tablet computer. A wireless communication interface 40 is mounted to the casing 10. The wireless communication interface 40 receives the remote command from the mobile terminal 2. The remote command comprises information of at least one lens 21 to be controlled and the type of the operation. Specifically, one or more than one of the lenses 21 can be controlled by the remote command.

A controller 50 is positioned in the casing 10. The controller 50 is electrically connected to the wireless communication interface 40. The controller 50 obtains the remote command from the wireless communication interface 40, analyzes the remote command to determine the at least one lens 21 to be controlled and the type of the operation, and controls each determined lens 21 to perform the determined operation. For example, when the user wants to control the lenses 21 at the front and the back of the casing 10 to adjust focal length, the user can press buttons of the mobile terminal 2, to send the remote command to the panoramic camera 1. Thus, the controller 50 can control the lenses 21 at the front and the back of the casing 10 to adjust focal length.

When the type of the operation is zoom in or zoom out, and only some of the total number of the lenses 21 are controlled by the remote command, the image processor 30 directly seams the images of the lens 21 to be controlled with the images of other lens(es) 21 to form the panoramic image. That is, the image processor 30 does not need to adjust the size of the images of the lens 21 to be controlled, before seaming the images.

When the panoramic camera 1 is in the manual mode, each lens 21 can be manually controlled. That is, each lens 21 can be manually controlled to perform the operations of zoom in, zoon out, focal length adjustment, and aperture adjustment. In at least one exemplary embodiment, the casing 10 comprises a number of mechanical or virtual buttons (not shown). The user can press the buttons to control the panoramic camera 1 to perform the operations.

In at least one exemplary embodiment, each lens 21 can also be controlled by voice.

In at least one exemplary embodiment, a fish-eye lens (not shown) can be arranged in front of each lens 21, to increase the field of view of the lens 21. Each lens 21 has a resolution of about 7680×4320 (90-120p), and a focal variation ratio of 14, 22, 40, 76, and 101.

The casing 10 can be made of a metal having good thermal conductivity, to improve heat dissipation of the panoramic camera 1. For example, the casing 10 is made of copper or aluminum. A heat dissipation plate (such as graphene, not shown) can cover the casing 10 to further improve heat dissipation.

In another exemplary embodiment, referring to FIG. 1, the lens unit 20 can be connected to a power cable 200. An end portion of the power cable 200 facing away from the lens unit 20 protrudes from the casing 10, and is connected to a USB interface 201. Each USB interface 201 is connected to a battery 60. The battery 60 can provide electric power to the panoramic camera 1 when the panoramic camera 1 is powered on. In at least one exemplary embodiment, the power cables 200 of the lens units 20 are intertwined to form an intertwined structure 202. The battery 60 being positioned outside the casing 10 facilitates the disassembly of the battery 60. The battery can be a rechargeable battery.

In yet another exemplary embodiment, a solar panel 70 is mounted on the casing 10. The solar panel 70 absorbs solar energy, converts the absorbed solar energy to electric power, and outputs the electric power to the battery 60 to charge the battery 60.

In the above exemplary embodiment, each lens unit 20 has an independent battery 60. Different lens units 20 can share a single battery 60.

Each lens 21 can be switched between a common mode and a night viewing mode. In at least one exemplary embodiment, an infrared filter (not shown) covers each lens 21. When the lens 21 is in the common mode, the infrared filter works, which prevents infrared light from entering the image sensor 22, to cause the image sensor 22 to only sense visible light. When the lens 21 is in the night viewing mode, the infrared filter is turned off, to allow infrared light or far-infrared light to enter the image sensor 22 to form images.

The panoramic camera 1 further comprises a stand 80 position under and connected to the casing 10. The stand 80 supports the casing 10, and is adjustable for height. The stand 80 comprises a rotatable structure (for example, a rotation shaft, a hinge, or a ball bearing, not shown) that can rotate the stand 80 relative to the casing 10. In another exemplary embodiment, the stand 80 can be made of a thermal conductive material, which can dissipate heat generated by the lens unit 20, the image processor 40, and the controller 50. Or, an electric conductive tube containing thermal conductive liquid can be received in the stand 80 to dissipate heat.

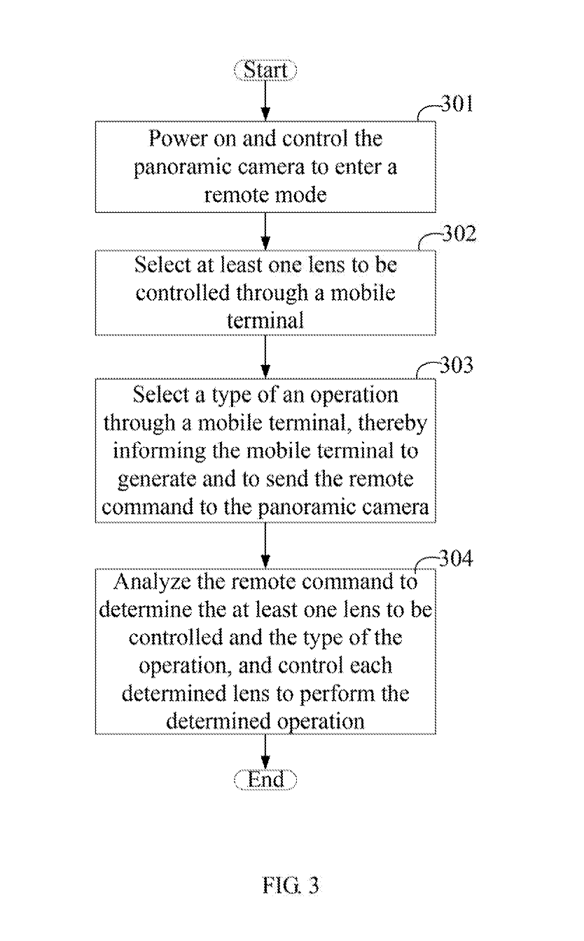

FIG. 3 illustrates an exemplary embodiment of a method for controlling the panoramic camera 1. The method is provided by way of example, as there are a variety of ways to carry out the method. The method described below can be carried out using the configurations illustrated in FIGS. 1-2, for example, and various elements of these figures are referenced in explaining example method. Each block shown in FIG. 3 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 301.

At block 301, the panoramic camera 1 is powered on, and is controlled to enter the remote mode.

At block 302, at least one lens 21 to be controlled is selected through the mobile terminal 2.

At block 303, the type of the operation is selected through the mobile terminal 2, thereby informing the mobile terminal 2 to generate the remote command and to send the remote command to the panoramic camera 1. The remote command comprises information of the at least one lens 21 to be controlled and the type of the operation which is required.

At block 304, the controller 50 obtains the remote command from the wireless communication interface 40, analyzes the remote command to determine the at least one lens 21 to be controlled and the type of the operation, and controls each determined lens 21 to perform the determined operation.

Depending on the embodiment, certain of the steps of method hereinbefore described may be removed, others may be added, and the sequence of steps may be altered. For example, in another exemplary embodiment, the sequence of selecting the at least one lens 21 to be controlled at block 702 and selecting the type of the operation at block 703 can be altered. It is also to be understood that the description and the claims drawn to a method may include some indication in reference to certain steps. However, the indication used is only to be viewed for identification purposes and not as a suggestion as to an order for the steps.

With the above configuration, when the panoramic camera 1 receives the remote command, the controller 50 can control at least one lens 21 to perform the required operations. Thus, it requires less time for operating the panoramic camera 1.

Furthermore, it can solve the problem of inconvenient manual operation being required, thereby improving the user's experience.

Even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

1. A panoramic camera comprising:
a casing;
at least two lenses mounted to the casing, each lens able to be independently controlled;
a wireless communication interface mounted to the casing and configured to receive a remote command from a mobile terminal, the remote command comprising information of at least one lens to be controlled and a type of an operation; and
a controller positioned in the casing, the controller configured to obtain the remote command from the wireless communication interface, analyze the remote command to determine the at least one lens to be controlled and the type of the operation, the type of the operation comprises zoom in, zoom out, focal length adjustment, aperture adjustment, and any combination thereof, the controller further configured to control each determined lens to perform the determined operation.

2. The panoramic camera of claim 1, wherein an image sensor is positioned behind each lens, the panoramic camera further comprises at least one image processor, the image processor is configured to obtain images from each image sensor, and seams the obtained images to form a panoramic image.

3. (canceled)

4. The panoramic camera of claim 1, wherein when the type of the operation is zoom in or zoom out, and the number of the lens to be controlled of the remote command is less than the total number of the lenses, the image processor directly seams the images of the lens to be controlled with the images of other lenses to form the panoramic image.

5. The panoramic camera of claim 1, wherein when the panoramic camera is switched to a manual mode, each lens is able to be manually controlled.

6. The panoramic camera of claim 1, wherein the casing is made of copper or aluminum.

7. The panoramic camera of claim 1, wherein the lens is connected to a power cable, an end portion of the power cable facing away from the lens protrudes from the casing, and is connected to a battery.

8. The panoramic camera of claim 7, wherein power cables of the lenses are intertwined to form an intertwined structure.

9. The panoramic camera of claim 8, wherein a solar panel is mounted on the casing, the solar panel absorbs solar energy, converts the absorbed solar energy to electric power, and outputs the electric power to the battery to charge the battery.

10. The panoramic camera of claim 1, further comprising a stand, wherein the stand position under and connected to the casing.

11. The panoramic camera of claim 10, wherein stand is made of a thermal conductive material.

12. A method for controlling a panoramic camera, comprising:
providing the panoramic camera which comprising a casing, at least two lenses mounted to the casing, a wireless communication interface mounted to the casing, and a controller received in the casing, each lens able to be independently controlled;
powering on the panoramic camera and controlling the panoramic camera to enter a remote mode;
selecting at least one lens to be controlled and a type of an operation through a mobile terminal, thereby informing the mobile terminal to generate the remote command and to send the remote command to the panoramic camera, the remote command comprising information of the at least one lens to be controlled and the type of the operation, the type of the operation comprises zoom in, zoom out, focal length adjustment, aperture adjustment, and any combination thereof; and
the controller obtaining the remote command from the wireless communication interface, analyzing the remote command to determine the at least one lens to be controlled and the type of the operation, and controlling each determined lens to perform the determined operation.

13. The method of claim 12, wherein the panoramic camera further comprises an image sensor positioned behind each lens and at least one image sensor, the method further comprises:
obtaining images from each image sensor; and
seaming the obtained images to form a panoramic image.

14. The method of claim 12, wherein when the type of the operation is zoom in or zoom out, and the number of the lens to be controlled of the remote command is less than the total number of the lenses, the images of the lens to be controlled is seamed with the images of other lenses to form the panoramic image.
